(19) United States
(12) Patent Application Publication
(10) Pub. No.: US 2009/0217950 A1
(43) Pub. Date: Sep. 3, 2009

(54) Method and apparatus for foam-assisted wafer cleaning

(75) Inventor: Boris Kesil, San Jose, CA (US)

Correspondence Address: BORIS KESIL;MultiMetrixs, LLC, # 200, 1040 Di Giulio Avenue, Santa Clara, CA, 95050, US

(73) Assignee: Multimetrixs, LLC

(21) Appl. No.: 12/074,174

(22) Filed: Mar. 3, 2008

(51) Int. Cl. B08B 13/00; B08B 3/04; B08B 5/00

(52) U.S. Cl. 134/21; 134/36; 134/26; 134/102.2; 134/182

(57) ABSTRACT

A foam-assisted wafer-cleaning and drying method and apparatus based on forming a funnel-shaped space between the base plate of the apparatus and the wafer to be cleaned and supplying a foam cleaning liquid to the aforementioned space through the central opening of the base plate for displacing the cleaning liquid foam consisting of a plurality of bubbles from the center of the wafer toward the wafer periphery with a constant speed of movement of the bubbles provided by gradually decrease of distance from the base plate to the wafer in the radial outward direction from the center of the wafer. The nanoparticles of contaminants are caught with a surface-tension force developed by bubble meniscuses on the wafer surface.

### FIELD OF THE INVENTION

The present invention relates to cleaning flat objects and, more specifically, to cleaning semiconductor wafers during production of electronic devices. In particular, the invention relates to a novel method and apparatus for semiconductor wafer cleaning and drying by using foam-cleaning agents.

### BACKGROUND OF THE INVENTION AND DESCRIPTION OF THE PRIOR ART

Stringent surface-contamination-control requirements outlined in the International Technology Roadmap for Semiconductors (ITRS) pose new challenges in the technology of wafer-surface preparation. To meet ITRS requirements for surface preparation and to overcome the posed challenges, new processes and technology are required.

Modern semiconductor chips are complex three-dimensional structures of transistors and other electrical components. Particles in deionized water (DIW) and other process fluids can create defects by clinging to wafers, thus interfering with photolithography, as well as physical and chemical vapor-deposition processes. The purity of DIW is particularly important because DIW is used as the final rinse in most fabrication processes before proceeding to the next process. The prevailing opinion in the semiconductor industry is that the maximum allowable diameter of particulate contaminants in DIW equals one-half the line width of a semiconductor. ITRS specifications, consistent with this guideline, for allowable particulate contamination in DIW are given in Table 1, where HP90 and HP65 refer to 90 nm and 65 nm line widths, respectively.

TABLE 1
Critical factors affecting device yield that should be controlled
during surface-preparation processes
(http://www.semiconductor.net/article/CA456677.html)

| Technology Nodes | HP90 | HP65 |
|---|---|---|
| Particle diameter (nm) | 45 | 32.5 |
| Particle count (number/wafer) | 75 | 80 |
| Critical surface metal (10¹⁰ atoms/cm²) | 0.5 | 0.5 |
| Surface roughness, RMS (Å) | 4 | 4 |
| Silicon loss (Å/cleaning step) | 1 | 0.5 |
| Oxide loss (Å/cleaning step) | 1 | 0.5 |

Currently there are several processes, as well as cleaning tools, that employ various physical principles of particle removal. These processes, which are listed below, differ according to the drag forces that remove contaminant particles from the object being cleaned.

Process 1: Particle-removal force is a viscous friction force in the flow of cleaning liquid. This takes place in a substantially laminar flow of liquids, and process efficiency is limited by the thickness of the boundary layer between the moving flow of liquid and the surface of the wafer to be cleaned.

Process 2: Particle-removal force is a random force that occurs as a result of a tangential breakdown in the turbulent flow of cleaning liquid. This case is observed in a substantially turbulent flow of liquid when the velocity of liquid flow is higher than the velocity in laminar flow. In reality, process efficiency is limited because of the difficulty in reaching a higher velocity of flow and because of cavitation, which causes deterioration of the surface being cleaned.

Process 3: Particle-removal force is a force occurring as a result of a tangential breakdown caused by turbulence in the flow of cleaning liquid. Turbulence in the cleaning liquid can be induced by exciting acoustic waves therein. This condition occurs in the majority of ultrasonic cleaning tools. Process efficiency is limited because of cavitation, which causes deterioration of the surface being cleaned.

Process 4: Particle-removal force is a friction force in the flow of a cleaning medium. Such force occurs in a substantially laminar flow of gases (e.g., CO₂) in the supercritical phase. A cleaning substance in the supercritical phase has kinematical viscosity, which is three orders less than in the ordinary condition. As a consequence, the boundary layer between the moving flow and the surface of the wafer being cleaned is approximately 10 times thinner than under ordinary conditions (mentioned in aforementioned Processes 1 and 2 above. The cost is high, and efficiency is limited because of equipment complexity and process.

Process 5: Particle-removal force is a surface-tension force that acts between the cleaning liquid and the particle to be removed. Cleaning processes of this type can be realized in several modifications, i.e., (a) in the well-known Marangoni process, which takes advantage of the surface tension gradient at the boundary between the wafer and the cleaning liquid; and (b) processes wherein the level of cleaning liquid into which the wafer is immersed is combined with ultrasonic waves induced in the liquid. Process efficiency is limited because of cavitation, which causes deterioration of the surface being cleaned, and a slow cleaning rate.

Process 6: Particle-removal force is a surface-tension force that occurs between the meniscus of the cleaning medium and the particle to be removed. The cleaning process of this type uses foam cleaning liquids, the process being based on the fact that meniscus surface tension on the phase boundary, i.e., on the boundary between the surface to be cleaned and the cleaning-liquid meniscus, has a gradient. The main disadvantage of the foam cleaning process is slow cleaning rate.

A modification of the aforementioned processes is a process in which the meniscus is created in a narrow gap between the surface to be cleaned and a special cleaning head that supplies cleaning liquid to the surface of the object and creates conditions for maintaining the meniscus. When the cleaning head is moved along the surface to be cleaned, then contaminant particles move together with the head under the effect of surface tension and are removed.

Practical realization of the processes described above is illustrated below by reference to some patents and patent application publications.

### Equipment for Process 1

As a rule, apparatuses of this group perform cleaning of each horizontally arranged wafer. Cleaning is carried out by means of deionized water, and drying is carried out with use of isopropyl alcohol in combination with nitrogen. The apparatus may employ pulsed-jet rinsing and variations thereof and IPA/N₂ mists and hot N₂ flows for drying. The apparatuses of this group may be designed with a single cleaning/drying chamber or with separate chambers for cleaning and drying.

An example of a wafer-cleaning apparatus for Process 1 is one disclosed in U.S. Pat. No. 7,300,524 issued in 2007 to T. Asano. The wafer-cleaning apparatus disclosed in this patent includes an indexer, a front-surface cleaning unit for cleaning the front surface of a substrate, a back-surface cleaning unit for cleaning the back surface of the substrate, a particle-inspecting unit for detecting distribution of particles adhering to the substrate, a reversing unit for reversing the substrate, and a transport section having a pair of transport units. Cleaning conditions of the front-surface cleaning unit or back-surface cleaning unit vary based on the distribution of particles on the substrate after the substrate is cleaned by the front-surface cleaning unit or back-surface cleaning unit and inspected by the particle-inspecting unit.

### Equipment for Process 2

The apparatus suitable for Process 2 is generally designed for cleaning vertically oriented wafers in a one-by-one manner. Cleaning is carried out with the use of deionized water. The apparatus may employ pulsed-jet rinsing. Drying is carried out with the use of isopropyl alcohol in combination with nitrogen in the form of a mist. Final drying is carried out by nitrogen. The apparatuses of this group may be designed with a single cleaning/drying chamber or with separate chambers for cleaning and drying.

An example of a wafer-cleaning apparatus suitable for Process 2 is the jet-pulsed cleaning apparatus disclosed in U.S. Patent Application Publication No. 20060174919 published in 2006 (inventor R. Randhawa). The apparatus cleans flat objects such as semiconductor wafers with a pulsed liquid jet emitted from a group of nozzles that can be installed in a vertically arranged rotating chuck on one or both sides of the wafer. The apparatus is comprised of a series of individual processing units, such as a loading unit, cleaning unit, drying unit, and an unloading unit, which are arranged circumferentially around a universal industrial robot capable of reaching any of the units and transferring the wafers between the units. Drying is carried out in the horizontal position of the wafer and may combine spin drying with chemical treatment in order to accelerate the drying process and to improve the quality of the drying process. All units are located in a sealed enclosure with controlled purity of the atmosphere inside the enclosure.

### Equipment for Process 3

One new approach to single-wafer cleaning uses an immersion-style chamber and a configuration of three megasonic transducers. The combined megasonic energy from these transducers is focused at the three-phase interface of wafer/liquid/air. Exposure of the entire wafer surface allows multiple acoustic wavefronts to be applied to the wafer. The wafer is swept up and down multiple times during cleaning in order to expose the entire wafer surface to the three-phase interface.

### Basic Disadvantage of Existing Wafer-Cleaning Equipment of Process 3

The exposure time of any die on a wafer to megasonic power during a 20-sec to 30-sec cleaning process is limited to milliseconds in order to minimize damage.

As shown in aforementioned Table 1, removal of 45 and 32.5 nm particles without etching underlying areas and causing structural damage is required for 90 and 65 nm technology nodes. This requirement cannot be met by using traditional approaches, such as 1:1:5 (NH₄OH:H₂O₂:H₂O) SC1/megasonic. Although SC1 is very effective in removing particles from wafer surfaces, it etches underlying materials excessively and damages the structures. (See Jagdish Prasad, AMI Semiconductor, Pocatello, Id.; Semiconductor International, Oct. 1, 2004).

Wafer cleaning has traditionally relied on the combination of strong chemistries and high-power megasonic energy to achieve cleaning efficiencies >90%. With new 65-nm processes now moving into the pre-production phase and 45-nm technologies in R&D, a major roadblock has emerged. Engineers face conflicting challenges of achieving high particle-removal efficiency (PRE) with no megasonics-induced damage to fragile device structures and ultra-stringent limits for material loss (i.e., oxide and Si consumption).

### Equipment for Process 4

Equipment of this group is based on cleaning combined with drying, wherein a wafer is gradually withdrawn from water into the vapor of isopropyl alcohol (IPA) and nitrogen. Due to the gradient of surface tension, water from the surface of the wafer is pulled back into the body of water, leaving the emerging surface free of contaminants and moisture. This process is described in many patent documents. Reference to some of these patent documents is given below.

U.S. Pat. No. 7,229,522 issued in 2007 50 T. Toshima, et al, discloses a substrate-processing apparatus that removes resist films formed on wafers by holding the wafers in a processing vessel and exposing the wafers to a mixed gaseous fluid of steam and ozone-containing gas into the processing vessel. To protect surfaces from corrosive action when subjected to mixed gaseous fluids, a coating of SiO₂ film is applied to the inner surface of the processing vessel and also to the surface of the components that are placed in the processing vessel.

U.S. Patent Application Publication No. 20070272278 published in 2007 (inventor B. Fishkin, et al) discloses a method and an apparatus for cleaning, rinsing, and Marangoni-drying substrates. A line of fluid is sprayed along a substrate surface to form an air/fluid interface line, and a line of drying vapor is supplied to the interface line to achieve Marangoni drying. Thus, a large portion of the substrate is simultaneously dried. A preferred apparatus employs a tank of cleaning and/or rinsing fluid. Above the tank is a source of rinsing fluid that directs the rinsing fluid to the surface of the substrate, forming a meniscus on the substrate surface as the substrate is lifted from the cleaning fluid; a drying vapor source directs drying vapor to the meniscus. The drying vapor lowers the surface tension of the meniscus, inducing a Marangoni flow of rinsing fluid from the surface of the substrate and thereby drying the substrate. The cleaning-fluid tank has a substrate-receiving-and-cleaning portion and a substrate-rinsing portion. The rinsing-fluid source and the drying-vapor source are enclosed by a drying enclosure above the rinsing portion of the tank. Thus, substrate loading, cleaning, rinsing, drying, and unloading are performed with a partial overlap in time.

U.S. Patent Application Publication No. 20060207636 published in 2006 (inventor J. Garcia, et al) discloses a multi-menisci processing apparatus. The apparatus includes a housing configured for installation in a substrate fabrication facility. The housing includes a manifold for use in preparing a wafer surface. The manifold is configured to include a first process window in a first portion of the manifold. A first fluid meniscus is capable of being defined within the first process window. Further included is a second process window in a second portion of the manifold. A second fluid meniscus is capable of being defined within the second process window. An arm is integrated with the housing, and the arm is coupled to the manifold such that the arm is capable of positioning the manifold in proximity with the substrate during operation. The apparatus therefore provides for the formation of multi-menisci over the surface of a substrate using a single manifold.

High-purity deionized water is typically used as a solvent. However, achieving the necessary high purity levels is very expensive. Indeed, all phases of the cleaning operation, including purchasing, transportation, storage, internal distribution, consumption, and disposal, are expensive.

Most of the substances used in the cleaning and chemical treatment processes, such as fluorides, solvents, acids, heavy metals, oxidizers, etc., are toxic, flammable, or otherwise hazardous or noxious.

Chemical treatment and cleaning operations are also major sources of chemical contamination of the final product. Such contamination results from errant surface reactants and physical contamination by undesirable, very small solid particles. These very low levels of contaminants are delivered to the product, in part from the chemical treating and cleaning materials themselves, even though they are ultrapure. They are also delivered to the product from fittings, piping, tanks, valves, and other components of storage and delivery systems.

Contaminants on semiconductor wafer surfaces exist as films, discrete particles or groups of particles, and adsorbed gases. Surface films and particles can be classified as molecular compounds, ionic materials, and atomic species. Molecular compounds are mostly particles or films of condensed organic vapors from lubricants, greases, photo resists, solvent residues, organic components from deionized water or plastic storage containers, and metal oxides or hydroxides. Ionic materials comprise cations and anions, mostly from inorganic compounds that may be physically adsorbed or chemically bonded, such as ions of sodium, fluorine, and chlorine. Atomic or elemental species comprise metals, such as gold and copper, which may be chemically bonded to the semiconductor surface, or they may consist of silicon particles or metal debris from equipment.

Semiconductor devices, especially dense integrated circuits, are vulnerable to all of these contamination sources. Sensitivity is due to small-feature sizes and thinness of the deposited layers on the wafer surface. These dimensions are in the submicron range. The small physical dimensions of the devices make them very vulnerable to particulate contamination, which can be caused by workers, equipment, or processing chemicals. As the feature size and films become smaller, the allowable particle size must be controlled to smaller dimensions. In general, particle size should be 10 times smaller than the minimum feature size. Currently, the minimum feature size for commonly available semiconductor chips is 0.25 μm, therefore suggesting particle control to 0.025 μm.

Conventional cleaning technologies using condensed-phase solutions when properly applied can remove a majority of the contaminants generated during chemical processing of semiconductor wafers. Liquid systems currently in use can deliver satisfactory results, and an acceptable product can be produced. However, the current trend is to require the chemical and equipment suppliers to provide increasingly clean products. Equipment and chemical suppliers are facing tremendous challenges as the feature size decreases. At the same time, semiconductor manufacturers do not want their costs to increase.

Another problem addressed by this invention is the drying of surfaces in the production of semiconductor wafers and similar devices.

Semiconductor wafers are not manufactured in a continuous process. Since there are many semiconductor wafer configurations, batches of wafers are processed through certain steps and are then stored. Later the batches are subjected to additional processing steps and are again stored. The processing and storage sequence may be repeated several times before processing is completed.

In general, at the end of each process sequence, the semiconductor wafers are dried, often immediately with start of the next step. Wafers can be transported from one process sequence to the next only after they have been dried, and they can only be stored safely when they are dry. The drying process is carried out frequently in the processing of a given wafer and therefore is very important.

Recently, isopropyl alcohol has become the preferred drying solvent. A variety of processes have been developed and commercialized using isopropyl alcohol either hot or cold, and as a vapor, a liquid, or a combination of vapor and liquid. Producers of semiconductor wafers have been moving toward reduced isopropyl alcohol usage because of its cost, fire hazards, disposal problems, and VOC (volatile organic compound) emissions.

A special group of equipment for Process 4 comprises a method and apparatuses based on foam application. Advantages of the processes and apparatuses of this type are the following:
single chamber for both cleaning and drying processes;
no metal parts in chamber, no contaminants introduced by processes;
no moving parts in chamber during process of cleaning and drying;
use of different chemical components for foam-creating liquids;
adjustment and control of foam over a wide range (including velocity of foam movement along wafer surface);
prospective for particle removal beyond 45 nm.

For example, U.S. Pat. No. 6,296,715 issued in 2001 to P. Kittle discloses surface cleaning and chemical treatment and drying of semiconductor substrates based on using foam as a medium instead of a condensed-phase liquid medium. By introducing foam into an overflow vessel during cleaning and chemical treatment, the foam is caused to pass over the substrate in moving contact therewith. Drying of the substrate is carried out using a water solution of carbon dioxide in a pressurizable vessel. By releasing the pressure in the vessel, a layer of foam is established on the surface of the solution. The solution is discharged from the vessel, causing the foam layer to pass over the substrate in moving contact therewith. Carbon dioxide reduces surface tension of the water, thereby enabling the foam layer to be produced and also assisting in the elimination of water from the surface of the substrate. In both cases, the use of foam reduces materials requirements and also reduces the quantity of particles deposited onto the substrate in the treatment process.

U.S. Patent Application Publication No. 20070135321 published in 2007 (inventor Bakul P. Patel, et al) relates to methods and compositions for treating a substrate surface using foam of at least one treatment chemical. The invention more particularly relates to the removal of undesired matter from the surface of substrates with small features, where such undesired matter may comprise organic and inorganic compounds such as particles, films from photoresist material, and traces of any other impurities such as metals deposited during planarization or etching. The method according to this invention for treating a substrate surface comprises generating a foam from a liquid composition, wherein the liquid composition comprises a gas; a surfactant; and at least one component selected from the group consisting of a fluoride, a hydroxylamine, an amine and periodic acid; contacting the foam with the surface of a substrate; and removing the undesired matter from the surface of the substrate.

### OBJECTS AND SUMMARY OF THE INVENTION

It is an object of the invention to increase the effectiveness of the chemical treatment and cleaning and drying operations, and to reduce the cost of such operations. Further objects are to improve the safety of the chemical treatment and cleaning and drying operations and to reduce the discharge of hazardous or noxious substances from the treating and cleaning operations. It is another object to provide a device and a method for cleaning semiconductor wafers by taking advantage of the desirable characteristic of foam, which from a volumetric standpoint consists mostly of gas and therefore delivers a reduced amount of small particles of contaminant to the surface of the wafer. A further object is to provide an apparatus for foam-based cleaning which has an extremely simple and inexpensive construction for both processes of cleaning and drying. It is a further object to provide the apparatus of the aforementioned type to be free of mechanically moving parts. Another object is to provide a foam-based cleaning method and apparatus that allow the use of different chemical components for foam-creating liquids, with adjustment and control of the foam parameters over a wide range.

The apparatus of the invention is intended for cleaning surfaces of semiconductor wafers with the use of a foam-cleaning-based technique. The apparatus comprises a closable shallow container with a funnel-like base plate that is tapered radially outward from the center of the container toward the periphery of the container so that in a central cross-sectional plane perpendicular to the bottom of the container, the aforementioned funnel forms an obtuse angle ranging from 100° to an angle close to 180°. The upper side or cover of the shallow container supports a wafer-gripping mechanism, e.g. in the form of three wafer-edge gripping fingers that can be moved radially inward for gripping the wafer or radially outward for releasing the wafer. The base plate has an outer diameter smaller than the inner diameter of the sidewall, or walls, of the container in order to form a peripheral foam-collecting space. The foam-collecting space has a foam-discharge opening connected to a foam-suppressing unit. The apparatus is provided with a fluid-supply unit that contains a foam-supply pipe and a pipe for the supply of IPA/N₂ mist or only N₂ (where “IPA” represents isopropyl alcohol and “N₂” represents gaseous nitrogen). These fluids can be selectively supplied individually or in combination through the aforementioned fluid-supply unit. The apparatus is further provided with a container that holds the foam-generating liquid, a foam generator, a deionized (DI) water reservoir, an IPA/N₂ mist generator, a gaseous nitrogen (N₂) tank, and an IPA tank. The DI-water reservoir is connected to the container that holds the foam-generating liquid, while the container is connected to the aforementioned fluid-supply pipe through the foam generator. Output from the foam generator comprises the aforementioned foam-supply pipe. The IPA tank is connected to the container that holds the foam-generating liquid and to the IPA/N₂ mist generator. It is understood that foam can be formed from many other components, and a combination of DI water with IPA and N₂ is given herein only as an example. In this case, the N₂ tank is connected to the fluid-supply pipe via a heater, which can be activated when necessary. The N₂ tank is also connected to the IPA/N₂ mist generator and to a foam generator. Inserted into the closable shallow container through the cover is a foam-displacing pipe that receives nitrogen from the N₂ tank through the heater.

The apparatus operates as follows. The cover is disconnected from the shallow container or pivotally turned for access to the wafer-gripping mechanism, and the wafer to be treated is inserted into the gripper and clamped by moving the gripping fingers radially inward. The cover—with the wafer in the gripped position—is repositioned onto the shallow container. The container is purged with nitrogen, and then the foam-generating mixture (composed of DI water obtained from the DI-water reservoir, IPA obtained from the IPA tank, and nitrogen obtained from the nitrogen tank) is supplied to the foam generator and from there to the funnel-shaped space defined by the lower surface of the wafer and the tapered upper surface of the base plate through the aforementioned fluid-supply pipe under positive pressure. Under the effect of this pressure, the foam is displaced radially outward over the surface of the wafer to be cleaned toward the foam collector and from the foam collector to the foam-suppressing unit. The foam consists of a plurality of gas bubbles that possess high wetting properties relative to the surface of the wafer. The composition of the foam components, i.e., DI water, IPA, and nitrogen, is selected so that the cleaning liquid that forms the bubbles does not possess 100% wettability relative to the wafer surface and forms a plurality of meniscuses on the wafer surface. Thus, under the effect of the aforementioned positive pressure, the meniscuses will slide on the wafer surface to the foam collector, and, in the course of their movement, will catch particles of contaminants that may have dimensions as small as 250 to 400 nm. A particle-catching force results from a surface-tension-force gradient in the meniscus area, i.e., in the area of contact of the bubble wall with the wafer surface. The funnel shape of the foam-guiding space provides uniformity in the speed of movement of the meniscuses along the wafer surface. If necessary, in order to prevent the foam from covering the upper surface of the wafer, gaseous nitrogen can be supplied under positive pressure through the upper nitrogen supply pipe, which is installed in the cover. This pressure should be sufficient for preventing the foam from covering the upper surface of the wafer but insufficient for interfering with the cleaning process.

Upon completion of the foam-cleaning step of the process, generation and supply of the foam is discontinued, and gaseous nitrogen is supplied to the funnel-shaped space for displacing foam residue from the treated surface to the foam collector.

If necessary, the apparatus can transfer to the drying process without removing the cleaned wafer from the wafer-gripping mechanism. The drying process of the invention is very efficient, especially if the cleaning process leaves “islands” of the cleaning liquid on the wafer surface. More specifically, a mist composed of IPA and N₂ is injected from the IPA/N₂ mist generator via the fluid-supply unit to the aforementioned funnel-shape space and precipitates on the wafer surface, and then the funnel-shaped space is purged with nitrogen supplied from the N₂ tank, if necessary, in a hot state. The sequence of drying-cycle operations can be repeated several times. The above procedure eliminates formation of spots caused on the wafer surface by evaporating the drops of cleaning liquid drops.

Upon completion of the drying operation, the shallow container is opened by raising the cover, and, if necessary, the wafer can be removed from the gripping mechanism, turned over, gripped with the gripping mechanism, and treated for cleaning on the other side (if this is a doubled-sided wafer) in the same manner as described above. If this is a one-sided wafer, upon completion of the drying cycle, the wafer can be gripped by the end effector of a mechanical arm and then can be sent to subsequent treatment or storage, e.g., in a FOUP.

The method of the invention consists of cleaning the surface of a wafer from contaminant particles having dimensions as small as 250 to 400 nm by forming a wafer-cleaning foam composed of DI water, IPA, and N₂, supplying the foam to the center of the wafer to be cleaned, positively moving the foam on the surface of the wafer radially outward, and cleaning the surface from contaminant particles by catching the contaminant particles with a force developed by meniscuses formed by the foam bubbles on the wafer surface. The method further comprises the step of displacing the residue of the foam from the wafer surface by supplying gaseous nitrogen under pressure from the center of the cleaning chamber, and, if necessary, drying the wafer after cleaning without changing the position of the wafer in the gripping mechanism by injecting a mist composed of IPA and N₂ to the aforementioned funnel-shape space and then purging the cleaning space with nitrogen, if necessary, in a hot state.

### BRIEF DESCRIPTION OF THE DRAWINGS

FIG. 1 is a general schematic view of the apparatus of the invention.

FIG. 2 is a partial view of the container of the invention at the point of connection thereof to the cover.

FIG. 3 is a sectional view of an N₂/IPA mist generator suitable for use in the apparatus of the invention.

FIG. 4 illustrates a modification of the invention for cleaning wafers in a double-sided mode.

### DETAILED DESCRIPTION OF THE INVENTION

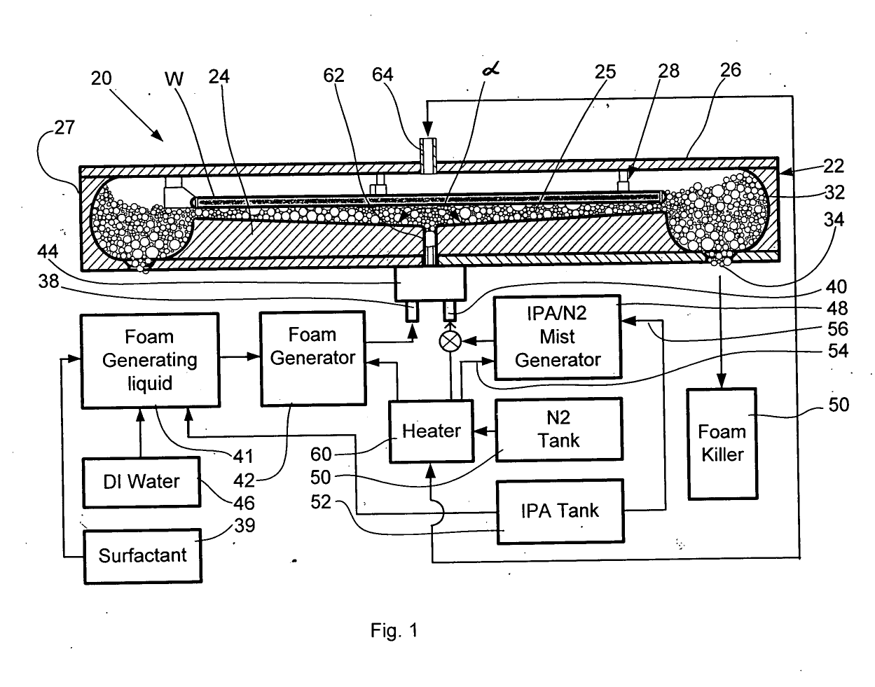

A general schematic view of the apparatus of the invention is shown in FIG. 1, which is a central cross-section of the apparatus. The apparatus is intended for cleaning surfaces of semiconductor wafer Ws with the use of a foam-cleaning-based technique. The apparatus, which as a whole is designated by reference numeral 20, contains a closable shallow container 22 with a funnel-shaped base plate 24, the upper surface of which is tapered radially outward from the center of the container 22 toward the periphery of the container so that in a central cross-sectional plane of the type shown in FIG. 1 perpendicular to the base plate 24 of the container 22, the aforementioned funnel shape forms an obtuse angle α ranging from 100° to an angle close to 180°. The distance from the base plate 24 to the facing surface of the wafer W gradually decreases from the center of the base plate 24 toward the periphery of the base plate 24. The obtuse angle α and the aforementioned distance are selected so as to provide a substantially constant speed of movement of the foam from the center of the base plate 24 to its periphery if gas under pressure is fed to the center of the base plate 24.

The upper side or cover 26 of the shallow container 22 supports a wafer W gripping mechanism 28, e.g., in the form of three wafer W edge-gripping fingers that can be moved radially inward for gripping the wafer W or radially outward for releasing the wafer W. An example of such mechanism is one disclosed in U.S. Patent Application Publication No. 2004/0102858 published May 27, 2004 (B. Kesil, et al). Thus, the interior 23 of the shallow closable container 22 is defined by the cover 26, side wall 27 of the container 22, and the tapered surface 25 of the base plate 24.

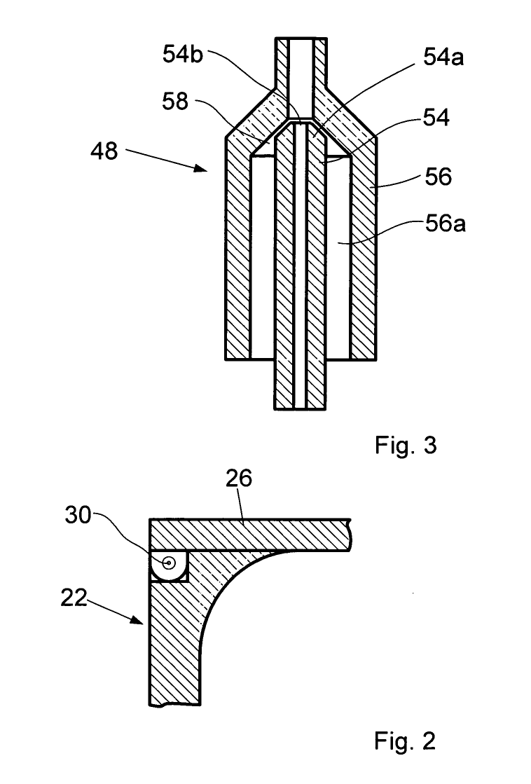

The gripping mechanism 28 is properly attached to the inner surface of the cover 26 with drive units (not shown) located outside of shallow container. The cover 26 can be disconnected from the upper end face of the shallow closable container 22 or can be pivotally connected thereto by means of a hinge 30 as shown in FIG. 2, which is a partial view of the container 22 in the point of connection thereof to the cover 26.

The base plate 24 has an outer diameter smaller than the inner diameter of the sidewall, or walls, of the container 22 in order to form a peripheral foam-collecting space 32. The foam-collecting space 32 has a foam-discharge opening 34 connected to a foam-suppressing unit 36. The foam-suppressing unit may be of any suitable type, e.g., one disclosed in U.S. Pat. No. 5,361,789 issued in 1994 to I. Yoshida, et al. After suppression of the foam, the used cleaning liquid can be discarded or filtered and recirculated.

The apparatus 20 is provided with a fluid-supply unit 44 that contains a foam-supply pipe 38 and a pipe 40 for the supply of IPA/N₂ mist or only N₂. The pipe 38 can be located concentrically inside the pipe 40 with an annular gap between both pipes. The aforementioned fluids can be selectively supplied individually or in combination to the closable container 22 through the aforementioned fluid-supply unit 44. The apparatus is further provided with a foam-generating liquid reservoir 41, which is connected to a foam generator 42. The foam-generating liquid reservoir 41, in turn, can be connected to a surfactant container 39 that can be added to the foam-generating liquid, if necessary.

The apparatus also contains a deionized (DI)-water reservoir 46, an IPA/N₂ mist generator 48 (where “IPA” represents isopropyl alcohol and “N₂” represents gaseous nitrogen), a gaseous nitrogen (N₂) tank 50, and an IPA tank 52.

The DI-water reservoir 46 is connected to the foam-generating liquid reservoir 41, which is connected to the aforementioned fluid-supply unit 44 through the foam generator 42. Structure and operation of the foam generator 42 are subjects of pending U.S. patent application Ser. No. ______ filed by the same applicant in 2008. The output from the foam generator 42 comprises the aforementioned foam-supply pipe 38. The IPA tank 52 is connected to the foam-generating liquid reservoir 41 and to the IPA/N₂ mist generator 48.

As shown in FIG. 3, which is a vertical sectional view of the N₂/IPA mist generator, this unit includes a nitrogen supply pipe 54 guided from the N₂ tank 50 and has a converging end 54a that terminates in the form of a nozzle 54b. The nitrogen supply pipe 54 is concentrically surrounded by an IPA supply pipe 56 so that an annular channel 56a is formed for the supply of IPA to a space 58 above the end of the nozzle 54b. When both media, i.e., nitrogen and IPA, are supplied under pressure, the combination of the nozzle 54b with the space 58 in which the IPA is supplied forms a Bernoulli-type diffuser 60 that facilitates suction of N₂ into the jet flows of the IPA emitted into the mist-forming space 58 from the IPA supply pipe 56, which is connected to the IPA tank 52. During drying of the wafer W with N₂/IPA at the appropriate stage of the wafer W drying cycle, the jet of the mist is emitted through an exit channel 62 into the aforementioned funnel-shaped space between the base plate 24 and the surface of the wafer W to be dried.

It is understood that the same effect will be obtained if nitrogen is supplied through the pipe 56 and IPA is supplied through the pipe 54. It is understood that foam can be formed from many other components, and the combination of DI water with IPA and N₂ is given herein only as an example.

In the illustrated embodiment, the N₂ tank 50 is connected to the fluid-supply unit 44, i.e., to the pipe 54, via a heater 60, which may be activated when necessary. The N₂ tank 50 is also connected to the IPA/N₂ mist generator 48 and to a foam generator 42. Inserted into the closable shallow container 22 through the cover 26 is a foam-displacing pipe 64, which receives nitrogen from the N₂ tank 50 through the heater 60.

The apparatus operates as follows. The cover 26 is disconnected from the shallow container 22 or is pivotally turned with the use of a hinge 30 (FIG. 2) for access to the wafer W gripping mechanism 28, and the wafer W to be treated is inserted into the gripper and is clamped by moving the gripping fingers radially inward. The cover 26 with the wafer W in the gripped position is repositioned onto the shallow container 22. The container 22 is purged with nitrogen, e.g., from the N₂ tank through the pipe 54 (FIG. 3), and then the foam-generating liquid (composed of DI water obtained from the DI-water reservoir 46, the IPA obtained from the IPA tank 52, and nitrogen obtained from the N₂ tank 50) is supplied to the foam generator from the foam-generating liquid reservoir 41 and then to the foam generator 42. The foam formed in the foam generator 42 is supplied to the funnel-shaped space defined by the lower surface of the wafer W and the tapered upper surface of the base plate 24 through the aforementioned fluid-supply unit 44 under positive pressure.

Under the effect of this pressure, the foam is displaced radially outward over the surface of the wafer W to be cleaned toward the foam collector 32 and from the foam collector 32 to the foam-suppressing unit 36.

Composition of the foam components, i.e., DI water, IPA, and nitrogen, is selected so that the cleaning liquid that forms the bubbles possesses a predetermined wettability relative to the wafer W surface and forms a plurality of meniscuses on the wafer W surface. Thus, under the effect of the aforementioned positive pressure, the meniscuses will slide on the wafer surface to the foam collector 32 and, in the course of their movement, will catch particles of contaminants that may have dimensions smaller than 400 nm, the removal of which presents a great problem if conventional methods are used. A particle-catching force results from a surface-tension-force gradient in the meniscus area, i.e., in the area of contact between the bubble wall and the wetted wafer surface. The funnel shape of the foam-guiding space provides uniform speed of movement of the meniscuses along the wafer W surface. If necessary, in order to prevent the foam from covering the upper surface of the wafer W, gaseous nitrogen can be supplied under a certain positive pressure through the foam-displacing pipe 64, which is installed in the cover 26. This pressure should be sufficient for preventing the foam from covering the upper surface of the wafer W but insufficient for interfering with the movement of the foam along the lower surface of the wafer.

Upon completion of the foam-cleaning step of the process, the generation and supply of foam is discontinued, and gaseous nitrogen is supplied to the funnel-shaped space to displace foam residue from the treated surface.

If necessary, the apparatus 20 can be switch to the drying mode without removing the cleaned wafer W from the wafer-gripping mechanism 28. The drying process of the invention is very efficient, especially if the cleaning process leaves “islands” of the cleaning liquid on the wafer W surface. More specifically, a mist composed of IPA and N₂ is generated in the above-described IPA/N₂ mist generator, is injected through the exit channel 62 (FIG. 3) to the aforementioned funnel-shaped space, and precipitates on the wafer surface. Following this, the funnel-shaped space is purged with nitrogen supplied via the pipe 54 from the N₂ tank, if necessary, in a hot state obtained by passing nitrogen through the heater 60. The sequence of the cleaning and drying operations can be repeated several times. The above procedure eliminates formation of spots caused on the wafer W surface by evaporating the drops of cleaning liquid.

Upon completion of the drying operation, the shallow container 22 is opened by raising the cover 26, and, if necessary, the wafer W can be removed from the gripping mechanism 28, turned over, gripped with the gripping mechanism 28, and treated for cleaning the other side (if this is a doubled-sided wafer W) in the same manner as described above. If this is a one-sided wafer W, upon completion of the drying cycle, the wafer W may be gripped by the end effector of a mechanical arm (not shown) and sent to subsequent treatment or to storage, e.g., in a FOUP (not shown).

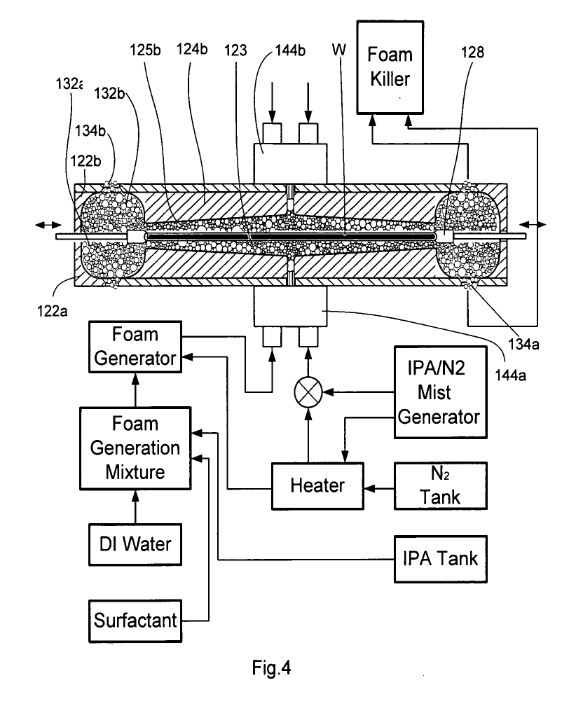

FIG. 4 illustrates a modification of the invention for cleaning wafers in a double-sided mode. In general, the apparatus of FIG. 4 is a symmetrically double version of the apparatus of FIGS. 1 to 3, except that the wafer-gripping mechanism, foam generator, DI-water container, N₂ tank, and IPA tank are common for both symmetrical parts. In view of similarity, the identical part and units of the apparatus of the invention will be designated by the same reference numerals as in the previous modification with the addition of 100 and with the addition of symbols “a” and “b” to upper and lower parts and units, respectively. Thus, the apparatus has a closable container composed of two symmetrical parts 122a and 122b, which are joined in butt connection with each other. Each part 122a and 122b has a respective base plate 124a and 124b of a funnel-shaped configuration formed by tapered surfaces 125a and 125b. In the closed state shown in FIG. 4, the container parts 122a and 122b form a common interior 123 into which a wafer W clamped in the gripping mechanism 128 is place for double-sided cleaning and, if necessary, for subsequent drying without opening the container and without changing the position of the wafer W in the gripping mechanism 128. The foam-collecting space is formed by two symmetrical cavities 132a and 132 formed in the peripheries of the respective base plates.

Each part 122a and 122b of the closable container supports centrally arranged liquid supply units 144a and 144b, which are identical in structure and contain pipes for the supply of nitrogen, IPA, and other fluids similar to those used in the apparatus of FIGS. 1 to 3. Since the structure of the two foam generators and two IPA/N₂ mist generators associated with respective container parts 122a are the same as in the apparatus of the previous embodiment, their images are omitted from the attached drawings, and their descriptions are omitted from the specification. The same relates to the foam-generating liquid reservoir, DI-water reservoir, IPA tank, N₂ tank, and foam-suppressing unit, which are common for both symmetrical parts and identical to those shown in FIG. 1 and described above.

During operation of the apparatus of FIG. 4, the identical symmetrical parts, i.e., foam generators, IPA/N₂ mist generators, and nitrogen supply pipes, operate synchronously and in the same manner as described in connection with the modification of FIGS. 1 and 3. The aforementioned symmetrical devices receive respective fluids from common fluid sources.

The method of the invention consists of cleaning the surface of a wafer W from contaminant particles having dimensions smaller than 400 nm by forming a wafer-cleaning foam composed of DI water, IPA, and N₂, supplying the foam to the center of the wafer W to be cleaned, positively moving the foam on the surface of the wafer W radially outward, and cleaning the surface from contaminant particles by catching the contaminant particles with a force developed by meniscuses formed by the foam bubbles on the wafer surface. The method further comprises the step of displacing foam residue from the wafer surface by supplying gaseous nitrogen under pressure from the center of the cleaning chamber, and, if necessary, drying the wafer after cleaning without changing the position of the wafer in the gripping mechanism 28 by injecting a mist composed of IPA and N₂ to the aforementioned funnel-shaped space and then purging the cleaning space with nitrogen, if necessary, in a hot state.

For double-sided treatment, the sequence of operations is the same, but treatment is carried out simultaneously from both sides using the same sources of foam-generating liquid, nitrogen, and IPA.

Thus, it has been shown that the present invention increases the effectiveness of chemical treatment and cleaning and drying operations, and reduces the cost of such operations. The invention improves safety of the chemical treatment and cleaning and drying operations and reduces the discharge of hazardous or noxious substances from treating and cleaning operations. The apparatus and method of the invention take advantage of the desirable characteristic of foam, which from the volumetric standpoint consists mostly of gas and therefore delivers a reduced amount of small particles of contaminant to the surface of the wafer. The apparatus of the invention for foam-based cleaning has an extremely simple and inexpensive construction, with a single chamber for both processes of cleaning and drying. The apparatus is free of mechanically moving parts and allows the use of different chemical components for foam-creating liquids with adjustment and control of the foam parameters over a wide range.

Although the invention has been shown and described with reference to specific embodiments, it is understood that these embodiments should not be construed as limiting the areas of application of the invention and that any changes and modifications are possible, provided these changes and modifications do not depart from the scope of the attached patent claims. For example, the cleaning liquid may have different components selected with reference to objects to be cleaned. The cleaning liquid may incorporate surfactants of various types. The components can be mixed in different proportions. The foam collectors and foam-suppressing units are shown schematically since they may have any construction suitable for collecting and suppressing the foam, respectively. It is understood that the funnel shape is not a strict geometrical cone and that it may be a substantially funnel shape, e.g., with a slight increase in the taper angle toward the periphery.

1. A method of foam-assisted cleaning of semiconductor wafers comprising the steps of:
providing a funnel-shaped space between the surface of the semiconductor wafer to be cleaned and a plate having a center coaxial with the center of the semiconductor wafer and a tapered surface that tapers radially outward from aforementioned center so that the distance from the plate to the aforementioned surface of the wafer gradually decreases from the center toward the periphery;
forming a foam from a cleaning fluid and supplying said foam under positive pressure to the aforementioned space through the aforementioned center of the plate; and
cleaning the surface of the semiconductor wafer by displacing the foam from the center of the plate toward the periphery of the semiconductor wafer and in contact with the surface of the semiconductor wafer with substantially constant velocity provided by the aforementioned gradual decrease of the distance from the plate to the aforementioned surface of the wafer.

2. The method of claim 1, wherein the foam is prepared from deionized water and alcohol.

3. The method of claim 2, wherein the aforementioned alcohol is isopropyl alcohol.

4. The method of claim 3, wherein the foam is prepared by further using gaseous nitrogen.

5. The method of claim 1, wherein the cleaning liquid possesses at least partial non-wettability with respect to the surface of the semiconductor wafer.

6. The method of claim 5, wherein the semiconductor wafer contains contaminant particles, the foam comprises a plurality of bubbles moving from the center of the semiconductor wafer toward the wafer periphery, the step of cleaning is carried out due to the fact that the foam forms a plurality of meniscuses between the bubbles and the surface of the semiconductor wafer, and particle-removal force is a surface-tension force that acts between the bubbles and the particles to be removed.

7. The method of claim 4, wherein the cleaning liquid possesses at least partial non-wettability with respect to the surface of the semiconductor wafer.

8. The method of claim 7, wherein the semiconductor wafer contains contaminant particles, the foam comprises a plurality of bubbles moving from the center of the semiconductor wafer toward the wafer periphery, the step of cleaning is carried out due to the fact that the foam forms a plurality of meniscuses between the bubbles and the surface of the semiconductor wafer, and particle-removal force is a surface-tension force that acts between the bubbles and the particles to be removed.

9. The method of claim 1, further comprising a step of drying without changing position of the semiconductor wafer relative to the aforementioned plate, the step of drying being carried out by supplying gaseous nitrogen under pressure to the aforementioned space through the center of the plate and displacing the foam from the aforementioned space in the radial outward direction.

10. The method of claim 9, further comprising the step of eliminating spots that can form on the surface of the semiconductor wafer after removal and evaporation of the cleaning liquid, said step of eliminating spots comprising supply of a mist composed of isopropyl alcohol and nitrogen into the aforementioned space through the central opening of the plate.

11. An apparatus for foam-assisted wafer cleaning, comprising:
a closable container having an interior, a cover that can be opened or removed, and a funnel-shaped base plate that has a central opening, a periphery, and a tapered surface that tapers radially outward from aforementioned central opening toward aforementioned periphery;
a wafer-gripping mechanism for supporting the semiconductor wafer to be treated in a cleaning position, in which at least one funnel-shaped space is formed between the semiconductor wafer in said cleaning position, the center of the semiconductor wafer being coaxial with the center of the central opening in the base plate, and a distance from the base plate to the aforementioned surface of the wafer gradually decreasing from the central opening toward the periphery;
a fluid supply unit connected to the aforementioned central opening;
a foam generator connected to the aforementioned fluid supply unit and intended for converting cleaning liquid into foam; and
a cleaning-liquid source connected to the foam generator.

12. The apparatus of claim 11, wherein the cleaning-liquid source comprises at least a reservoir with deionized water, a reservoir with alcohol, and a source of gaseous nitrogen under pressure.

13. The apparatus of claim 12, further comprising a foam-suppressing unit connected to the aforementioned space on the aforementioned periphery.

14. The apparatus of claim 13, further comprising at least one pipe located coaxially with respect to the aforementioned central opening and connecting the aforementioned interior of the closable container with the aforementioned source of gaseous nitrogen.

15. The apparatus of claim 12, further comprising a source of isopropyl alcohol and a mist generator, which is connected to the source of gaseous nitrogen under pressure and to the source of isopropyl alcohol and is intended for forming a nitrogen/isopropyl-alcohol mist for supply to the aforementioned interior.

16. The apparatus of claim 15, wherein the mist generator comprises a Bernoulli-type diffuser.

17. An apparatus for foam-assisted wafer cleaning, comprising:
a closable container having an interior, a cover that can be opened or removed, and two funnel-shaped base plates arranged symmetrically above and below the wafer, both surfaces of which are to be cleaned, both base plates having coaxial central openings, peripheries, and respective tapered surfaces that taper radially outward from aforementioned central openings toward aforementioned peripheries;
a wafer-gripping mechanism located between the aforementioned base plates for supporting the semiconductor wafer to be treated in the cleaning position, in which two symmetrical, funnel-shaped spaces are formed between the surfaces of the semiconductor wafer in said cleaning position and the aforementioned tapered surfaces of both base plates, the center of the semiconductor wafer being coaxial with the centers of the central openings in the base plates, and distances from the base plates to the aforementioned surfaces of the semiconductor wafer gradually decreasing from the central openings toward the peripheries;
two fluid supply units, each being connected to respective central openings,
a foam generator connected to the aforementioned fluid supply units and intended for converting cleaning liquid into foam; and
a cleaning-liquid source connected to the foam generator.

18. The apparatus of claim 17, wherein the cleaning-liquid source comprises at least a reservoir with deionized water, a reservoir with alcohol, and a source of gaseous nitrogen under pressure.

19. The apparatus of claim 18, further comprising a foam-suppressing unit connected to the aforementioned space on the aforementioned periphery.

20. The apparatus of claim 19, further comprising:
two pipes located coaxially with respect to the aforementioned central openings and connecting the aforementioned interior of the closable container with the aforementioned source of gaseous nitrogen; and
a source of isopropyl alcohol and a mist generator, which is connected to the source of gaseous nitrogen under pressure and to the source of isopropyl alcohol and is intended for forming a nitrogen/isopropyl-alcohol mist for supply to the aforementioned interior.
